(19) United States
(12) Patent Application Publication
(10) Pub. No.: US 2011/0317511 A1
(43) Pub. Date: Dec. 29, 2011

(54) APPARATUS FOR MIXING HAIR COLORANT CHEMICALS

(76) Inventor: Steven Dobay, Fresh Meadows, NY (US)

(21) Appl. No.: 13/156,695

(22) Filed: Jun. 9, 2011

Related U.S. Application Data
(60) Provisional application No. 61/397,292, filed on Jun. 9, 2010.

(51) Int. Cl. B01F 7/00

(52) U.S. Cl. 366/130

(57) ABSTRACT

An apparatus is provided which can easily, efficiently, reliably and thoroughly blend or mix hair colorant chemicals while minimizing stylist exposure to noxious fumes. The apparatus may include a mixing bowl molded from a polymeric material, an interlocking lid molded from the same or similar polymer, a specially designed top lid, a motorized handle, and a stiffing paddle or whisk having a rotatable shaft which passes through a sealing means removably affixed to the specially designed top lid and thence engaging a driving end of the motorized handle. The top lid incorporates interlocking means at its outer edge such that it can be easily twist-locked into intimate contact with the bowl which is provided with mating lock surfaces. When engaged, mating surfaces of the top lid and bowl form a seal which prevents or minimizes escape of mixture ingredients and odors from the enclosed volume defined by and between the lid and the bowl.

### CROSS-REFERENCE TO RELATED APPLICATION

This application claims the benefit of co-pending application Ser. No. 61/397,292, filed Jun. 9, 2010, and which is incorporated herein by reference.

### BACKGROUND OF THE INVENTION

1. Field of the Invention

The present invention relates to a mixing machine having improved means for efficient, safe and effective mixing of hair colorant chemicals and related articles.

2. Description of the Prior Art

Persons desirous of improving their cosmetic appearance often visit hair salons where they will pay hair stylists to perform various treatments to their hair. Such treatments might include among other things cutting, styling, curling, straightening and coloring. Coloring treatments include a wide variety of options such as darkening existing color, masking unwanted gray, lightening, bleaching, highlighting and more. These coloring treatments invariably employ a variety of chemicals which must be prepared according to each client's particular situation. This chemical preparation most often includes the mixing of two or more substances which may be in any combination of liquid, syrup, paste and powder forms. There is a broad range of viscosities for the liquids—some being as thin as water and others closer to thick syrup.

Stylists employed in these hair coloring activities generally move to a separate room from the client where appropriate chemicals are selected, apportioned out of bulk containers or small packets into a mixing bowl according to known volume ratios and then manually mixed together. The stylist then carries the mixture back to the client where suitable means are used to apply the mixture to the client's hair.

A disagreeable characteristic of these chemicals is that they release foul smelling odors. Although traces of such odors are certainly noticeable near the separate containers which hold the individual components of the mixture, much stronger odors are released during the process of mixing the substances together and agitating them sufficiently to assure a homogeneous mix. One of the primary reasons for preparing the coloring mixtures in a room separated from the client is to reduce, as much as possible, exposure of the client to these odors. Nevertheless, the stylist must suffer from the discomfort and possible health effects of routine extended exposure to these odors and noxious fumes released by these colorant chemicals when preparing the hair coloring mixture.

A second difficulty with certain combinations of these chemicals is that the task of thorough mixing can be quite challenging. Mixtures having powdery components require careful, moderately slow kneading to combine them with thin liquid components. Other combinations of syrupy and watery components are best mixed with more of a beating, high speed agitation. Incomplete mixing will almost always lead to unsatisfactory hair coloring treatment.

A third difficulty encountered with certain mixtures is the need to follow the mixing process with a pause or resting period where the mixture might undergo frothing and then settling phases before it is ready for use.

These matters of mixing and settling consume valuable time such that the client's patience can occasionally be taxed. Additionally, more clients could be accommodated in a day if this time were reduced.

Existing chemical preparation apparatus used in hair salons is entirely manual. It typically consists of a variety of open mixing bowls, hand held mixing brushes, shaker bottles and the like.

It can be readily appreciated that the hair colorant mixing process is generally far less than satisfactory. Difficulties encountered with inadequate blending of components, exposure to noxious fumes and wasted time are all troublesome aspects of the hair stylist's occupation.

The inventor of this device is unaware of any previous attempts to provide the novel attributes contemplated by this invention. A variety of apparatus is available for mixing liquids, powders and syrups. Some such equipment might include laboratory mixers, kitchen cake batter mixers and the like. These devices and others like them are not readily adapted to hair salon environments with the unique combinations of smelly, troublesome constituents and the need to maintain high efficiency.

### OBJECTS AND SUMMARY OF THE INVENTION

It is an object of the present invention to provide apparatus which can easily, efficiently, reliably and thoroughly blend/mix hair colorant chemicals while minimizing stylist exposure to noxious fumes.

It is another object of the present invention to provide a mixing apparatus for hair colorant chemicals which is easily employed such that little training or auxiliary equipment is needed to accomplish the task.

It is still another object of the present invention to provide a device for mixing hair colorant chemicals which is sufficiently robust to withstand constant use, exposure to various chemical solutions, have provision for different viscosity liquids and mixing protocols and be reasonable in cost such that a typical hair salon can afford to purchase several for use by their stylists.

The present invention contemplates a novel means for dealing with all of the design demands described previously.

In a preferred embodiment, the present invention for mixing hair colorant includes a mixing bowl molded from a polymeric material such as polypropylene or polyethylene, an interlocking lid molded from the same or similar polymer, a specially designed top lid, a motorized handle, and a stirring paddle or whisk having a rotatable shaft which passes through a sealing means removably affixed to the specially designed top lid and thence engaging a driving end of the motorized handle.

The top lid incorporates interlocking means at its outer edge such that it can be easily twist-locked into intimate contact with the bowl which is provided with mating lock surfaces. When engaged, mating surfaces of the top lid and bowl form a seal which prevents or minimizes escape of mixture ingredients and odors from the enclosed volume defined by and between the lid and the bowl. The bowl edge is preferably not circular but includes protrusions for a pouring spout and structure located approximately opposite said spout for wiping excess coloring mixture off application brushes and also a handle. The top lid is shaped at its edge so that, upon closing, it closely follows the non-uniform curvature of the bowl edge.

Preferably, the shape of the top lid is generally that of an inverted shallow bowl with a flat upper surface and curving walls dropping down to meet the edge. This inverted bowl shape allows capture of fluids following mixing and disengagement from the bowl when the top lip is turned upside down and set aside. Protruding from the flat upper surface of the top lid is a cylindrical neck with a central hole and external threads for locking engagement with a removable cap having complementary, interiorly-formed threads to mate with the threaded neck of the top lid and which further contains sealing means for sliding/rotating contact with the rotatable paddle shaft. The axis of this cylindrical neck is preferably located coaxially with the central axis of the bowl.

The paddle or whisk is preferably positioned within the bowl to be in close proximity to the interior walls and floor of the bowl but to allow suitable clearance therewith so as to assure satisfactory shearing action on substances placed therein when rotated within said bowl.

The motorized handle is removably engaged to the end of a shaft forming part of the paddle with hexagonal or other suitable engagement means. The handle preferably includes a body or housing defining an interior cavity, a low voltage, DC (direct current) electric motor, suitable geared speed changing mechanism (if required to provide either or both of greater torque or rotational speed to allow for the thorough mixing of the hair colorant chemicals) and one or more batteries situated within the interior cavity. The batteries are either of rechargeable or non-rechargeable type. The motorized handle further incorporates structure to actuate bi-directional rotational motion by means of a switch mounted on its housing. The handle also includes means, such as a switch, to switch alternately from a high speed, relatively low torque setting to a low speed, high torque setting. The preferred form of the housing of the motorized handle includes at one axial end thereof a driving nose and at the opposite axial end an enlarged cylindrical base with a flat bottom to provide a stable resting surface when the top lid assembly is disengaged from the bowl, inverted and set down with the flat bottom resting on a table or other horizontal support surface.

The handle housing may further have situated thereon one or more illuminating indicators, such as light emitting diodes (LEDs), which are connected to a battery monitoring circuit provided within the interior cavity of the housing and coupled thereto, to provide an indication to the user of the mixing apparatus the state of charge or condition of the batteries of the motorized handle.

The paddle or whisk is preferably provided in a variety of shapes and materials to facilitate blending of mixtures having a wide range of consistencies. One preferred embodiment of the paddle consists of rubberized blades disposed on opposite sides of a central axis and having an outer edge geometry shaped such as to be in close proximity to or engaging the inner walls and bottom of the bowl. The paddle geometry, combined with its preferred flexible rubber construction, provides a positive wiping action against the bowl interior in order to create desirable shearing of powders and thick semi-liquid ingredients for thorough mixing. The paddle structure may also include several apertures, circular in shape and of appropriate diameter and number, to effect a desired shearing action of thick ingredients while precluding useless plowing of ingredients during rotation as may occur without such apertures. The rubberized paddle is preferably used at a low speed, high torque setting of the motorized handle.

Other embodiments of the paddle preferably include open metallic forms intended for high speed mixing of thin liquids. These open forms, although shaped to generally complement the interior shape of the bowl, and more particularly, the interior wall and bottom surface curvatures of the bowl, are preferably provided with an offset gap from the bowl surfaces such that they preferably do not touch the interior surfaces of the bowl when driven in rotational motion by the motorized handle.

Another embodiment of the present invention utilizes the same sealing cap as the bowl version but substitutes a bottle for the bowl and lid. The bottle is preferably formed as a single piece construction with the same diameter, threaded cylindrical neck formation as previously disclosed with respect to the top lid such that it receives and engages the sealing cap along with the motorized handle and suitable mixing blades operatively coupled to the motorized handle. Certain optional and preferred mixing blades for use with the bottle are metallic or plastic forms designed to pass through the relatively narrow bottle neck but closely approach the bottle interior surfaces during mixing. Other mixing blades for use with the mixing bottle may include collapsible and fixed propeller shapes. All such blade geometries preferably include a central round shaft which removably passes through the sealing cap and presents hexagonal or other engagement means at its proximal axial end for coupling to the motorized handle.

The bowl embodiment of the present invention is utilized as follows:
1. The empty bowl is placed on a flat surface.
2. The sealing cap is screwed onto the top lid.
3. A mixing paddle or whisk is selected, inserted from the underside of the top lid, through the sealing cap until it engages a fixed stop.
4. Various chemicals are dispensed into the bowl in appropriate amounts as determined by the stylist.
5. The top lid and mixing paddle assembly are then placed onto the bowl, rotated approximately 18° counterclockwise (or clockwise) such that downwardly extending locking tabs align with mating slots formed in an outwardly extending edge on the bowl.
6. The top lid is then rotated clockwise (or counterclockwise) towards a lock position until further rotation is prevented by locking tab structures formed on the bowl edge. In this locked position, the bowl spout and a matching lid protrusion will be aligned.
7. The motorized handle is then grasped and suitable switches are actuated to rotate the mixing paddle or wand at appropriate speeds and directions to thoroughly mix the chemical ingredients within the bowl edge.
8. The device is then allowed to rest as necessary for whatever settling time is needed. Resting or delay time might also be extended to accommodate any additional time needed for unforeseen delays in readying the client for treatment. During these mixing and settling times, the release of noxious fumes into the room air is prevented or at least minimized.
9. When it has been determined that the client is ready to receive the coloring treatment, and after the mixture has settled, the lid is rotated counterclockwise (or clockwise) approximately 18° to a second rotational stop position and lifted up and away from the bowl. The top is immediately inverted—motorized handle down—and placed onto the table top with the flat bottom of the handle resting thereon.
10. The bowl with its prepared mixture is then carried out of the preparation room and to the client where administration of the chemicals is carried out in normal fashion.

The bottle embodiment of the present invention is utilized as follows:
1. The empty bottle is placed vertically upright on a flat surface.
2. Various chemicals are dispensed into the bottle in appropriate amounts as determined by the stylist.
3. A mixing blade is selected, inserted from the underside of the sealing cap and slid further until it arrives at a fixed stop, as described previously with respect to the bowl embodiment.
4. The mixing blade with sealing cap is then inserted through the bottle neck and the sealing cap is screwed firmly onto the top of the bottle.
5. The bottle is then grasped in one hand and the motorized handle in the other. The motorized handle is then positioned over the mixing rod and lowered into engagement with the axial end of the shaft of the mixing blade. Suitable switches are actuated to activate the motor to rotate the mixing blade at appropriate speeds and directions to thoroughly mix the chemical ingredients.
6. The device is then allowed to rest as necessary for whatever settling time is needed. Resting or delay time might also be extended to accommodate any additional time needed for unforeseen delays in readying the client for treatment. During these mixing and settling times, the release of noxious fumes into the room air is prevented or at least minimized.
7. When it has been determined that the client is ready to receive the coloring treatment, and after the mixture has settled, the sealing cap is unscrewed from the bottle and together with the mixing blade and motorized handle, lifted away from the bottle and its mixed contents.
8. The sealing cap, mixing blade and motorized handle assembly is immediately inverted—motorized handle down—and placed onto the table top with the flat bottom of the handle resting thereon. Alternatively, the sealing cap and mixing blade are extracted from the motorized handle and placed in a wash sink or other container for subsequent cleaning.
9. The bottle is then recapped with a suitable nozzle top cap having a nozzle, which is used in hair salons for application of the colorant to the hair.
10. The nozzled bottle with its prepared mixture is then carried out of the preparation room and to the client where administration of the chemicals is carried out in normal fashion.

A preferred form of the salon mixing apparatus, as well as other embodiments, objects, features and advantages of this invention, will be apparent from the following detailed description of illustrative embodiments thereof, which is to be read in conjunction with the accompanying drawings.

### BRIEF DESCRIPTION OF THE DRAWINGS

FIG. 1 is an isometric view of the hair colorant mixing apparatus of the present invention shown in a first embodiment using a bowl.

FIG. 2 is an exploded side view showing individual elements of the first embodiment shown in FIG. 1.

FIG. 3 is an isometric view of mixing bowl 2.

FIG. 4 is an isometric view of top lid 3.

FIG. 5 is a detail isometric view of one locking tab of top lid 3.

FIG. 6 is a partial cutaway isometric view of sealing cap 4.

FIG. 7 is a partial cutaway isometric view of an assembly of sealing cap 4, sealing elements 8, top lid 3 and stirring rod 5.

FIG. 8 is an isometric view of stirring paddle 7.

FIG. 9 is a side elevation view of the hair colorant mixing apparatus of the present invention shown in a second embodiment using a bottle.

FIG. 10 is an exploded side view showing individual elements of the second embodiment shown in FIG. 9.

FIG. 11 is a cross-sectional view of a preferred form of the motorized handle of the mixing apparatus of the present invention.

FIG. 12 is an elevation view of a handle and applicator combination used in some embodiments of the present invention.

### DETAILED DESCRIPTION OF THE PREFERRED EMBODIMENTS

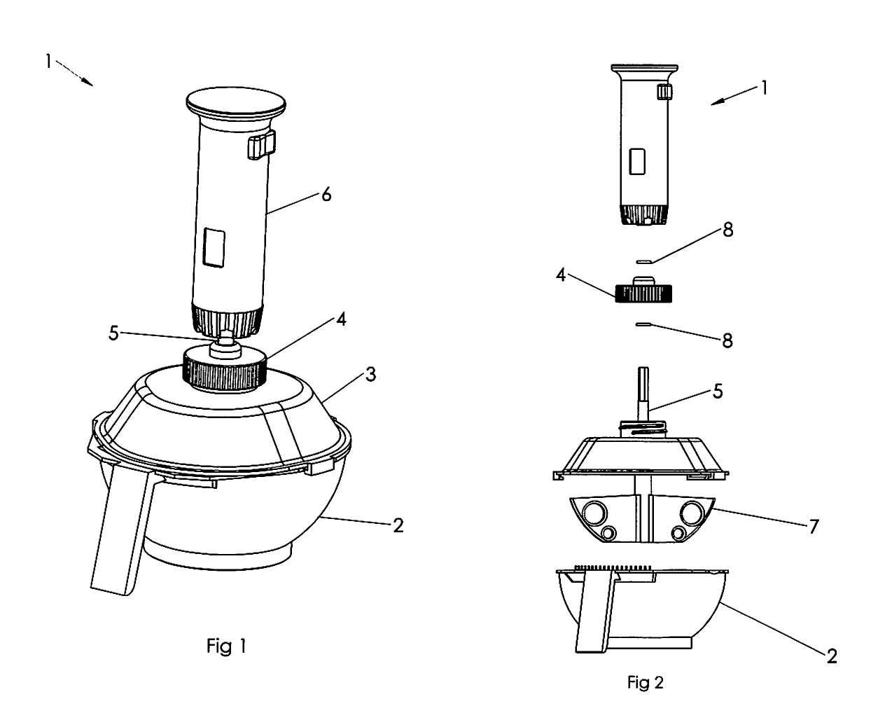

FIG. 1 shows the device 1 in its bowl configuration. Bowl 2 is positioned at the bottom, and top lid 3 is engaged above the bowl 2. Sealing cap 4 having a knurled outer surface is attached to the top lid 3, and stirring rod 5 passes through sealing cap 4 whence it then engages motorized handle 6 and couples with the rotatable shaft of the electric motor within handle 6.

FIG. 2 shows the device 1 in an exploded state. Stirring paddle 7 is seen to have a stirring rod 5 attached at its top. Sealing elements 8 are shown separated from their sealing cap 4. These sealing elements may take a variety of forms including o-rings or lip seals but are carefully sized to provide a combination of sealing and suitable frictional engagement with the outside diameter of stirring rod 5 such that the top lid 3 can be lifted away from the bowl while carrying away the stirring paddle. Frictional engagement must not be so high as to induce excessive drag torque on the rotating shaft as to stall the drive motor or transmission, if provided, within the motorized handle.

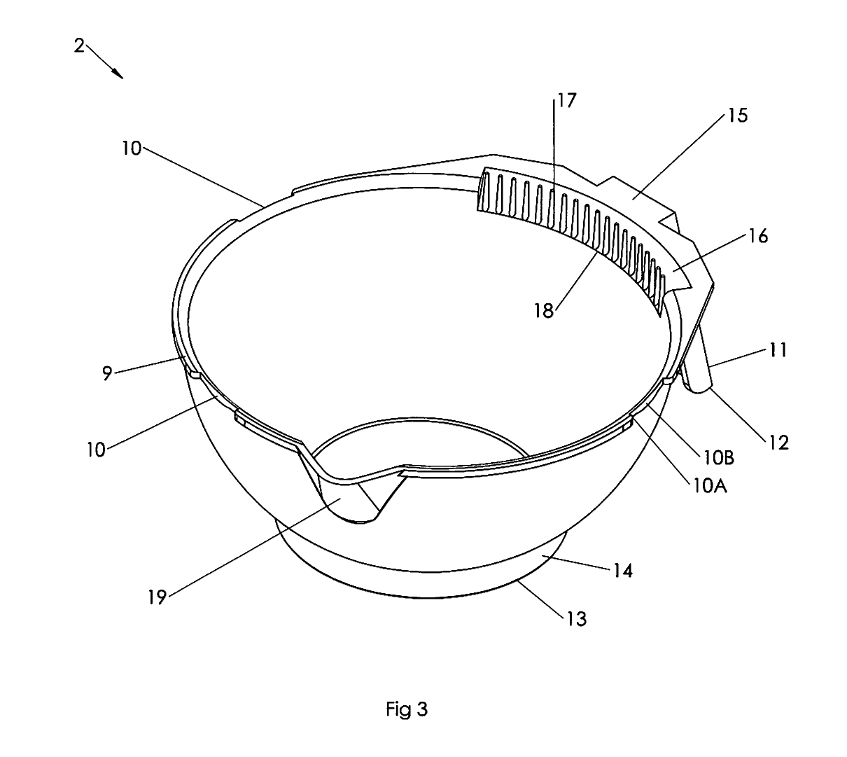

FIG. 3 shows mixing bowl 2 in its normal use position. The bowl incorporates a radially outwardly extending edge 9 which is interrupted in three places by notches of size and geometry suitable for receiving locking features of top lid 3. A handle 11 extends outwards and downwards from the back of the bowl 15 with its lower end 12 extending to meet the plane of the edge 13 at the bottom of base ring 14 forming part of the bowl. Base ring 14 provides additional stability for the bowl itself as well as the assembled device when placed upon a table. Adjacent to the back 15 of the bowl is a sloped area 16 with a series of spikes 17 arranged at its inside edge 18 to form an arcuate comb. This is known geometry intended to facilitate squeegee action on the bristles of application brushes which are drawn through the bristles after being dipped into the chemical mixture within bowl 2. This comb structure is preferably incorporated into the design of the bowl as it is deemed a highly desirable feature in styling treatment practice. It does, however, constitute a design challenge in that the locking features 10 needed for secure attachment of top lid 3 urge that the vertical planes intersecting the centerlines of the spout 19 and handle 11 be offset. The angle of offset was ideally found to be approximately 25°.

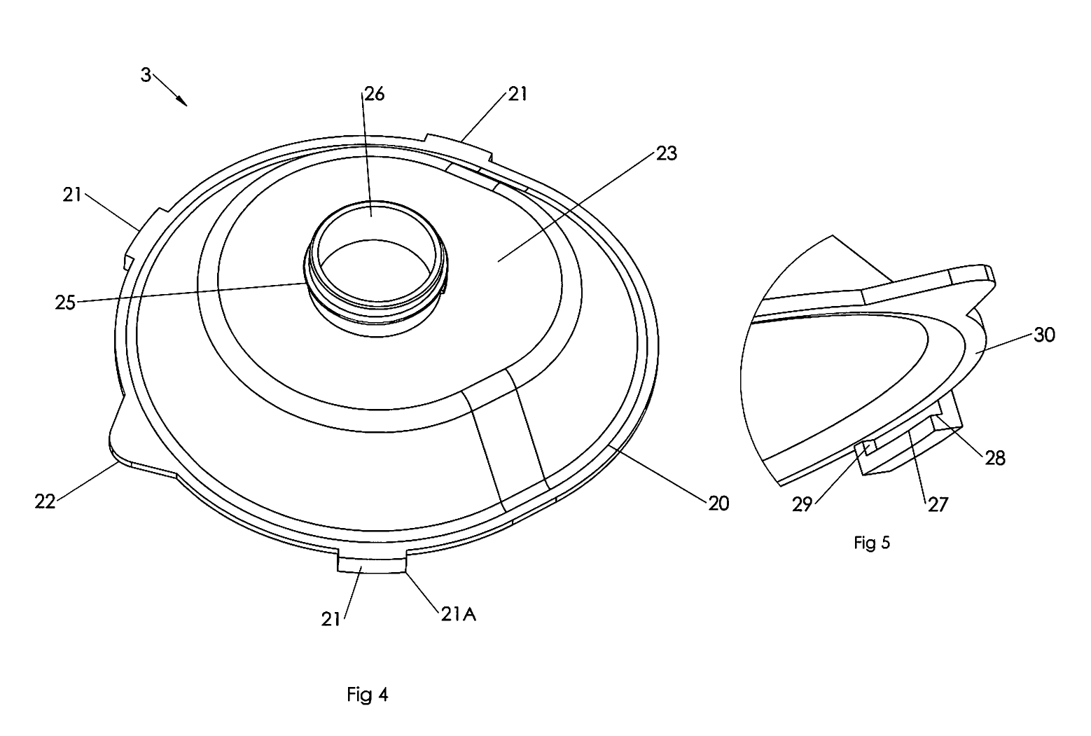

FIG. 4 show a view of the top lid 3. The edge 20 of this lid has three projections 21 which are located such as to mate and align with slots 10 of bowl 2. It also has a projection 22 and which is generally triangular in shape which serves to seal the spout 19 of bowl 2 when the top lid is locked onto the bowl. In the proximate center of flat surface 23 of the top lid 3 is a cylindrical projection with buttress form coarse thread 25 molded on the outside surface thereof and a central hole defined by wall 26.

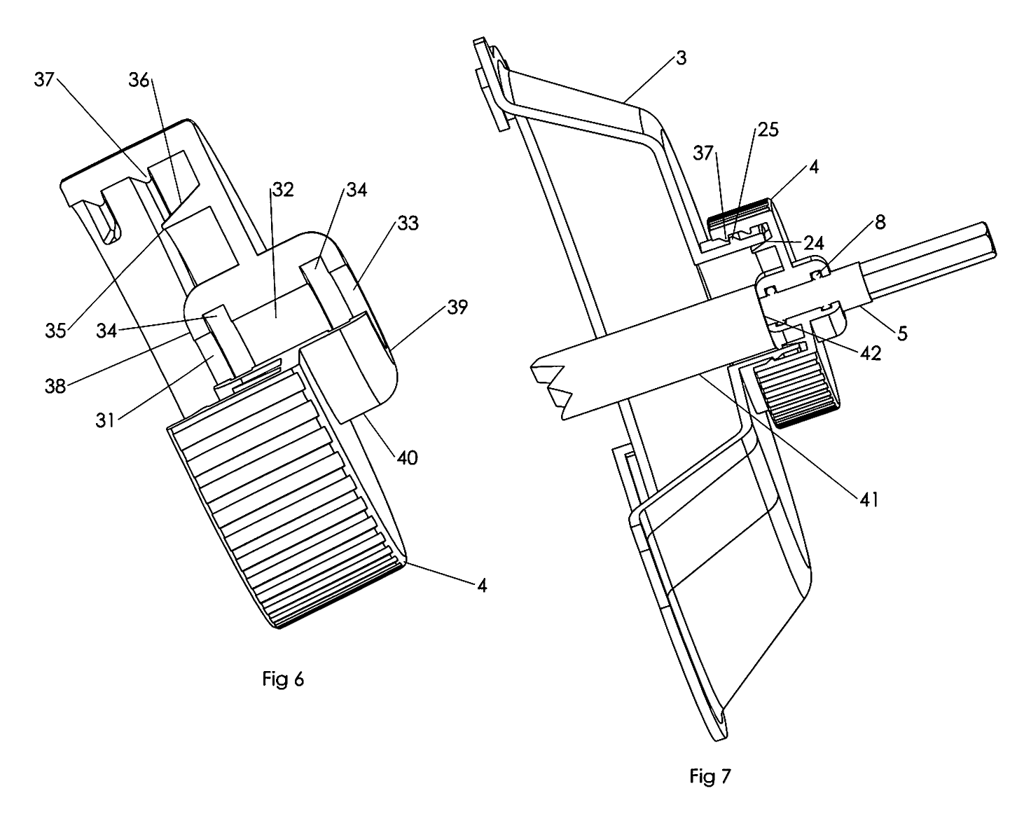

FIG. 5 shows the one locking tab 21A (part of projection 21) as it appears from the underside of the top lid 3. Edges 27 and 28 define the outer portions of a surface which will engage the bottom of edge 9 of bowl 2 when the top has been placed onto the bowl and then turned to its locking position. Wall 29 will limit the rotation angle of top lid 3 as it is twisted clockwise into its locked position when it strikes the end wall 10A of slot 10B (see FIG. 3) of bowl 2. Likewise, identical walls in the other two tabs or projections 21 will strike their respective end walls of slots 10 in bowl 2. Lower surface 30 of top lid 3 which serves to seal against upper surface 9 of bowl 2 can also be seen in this view.

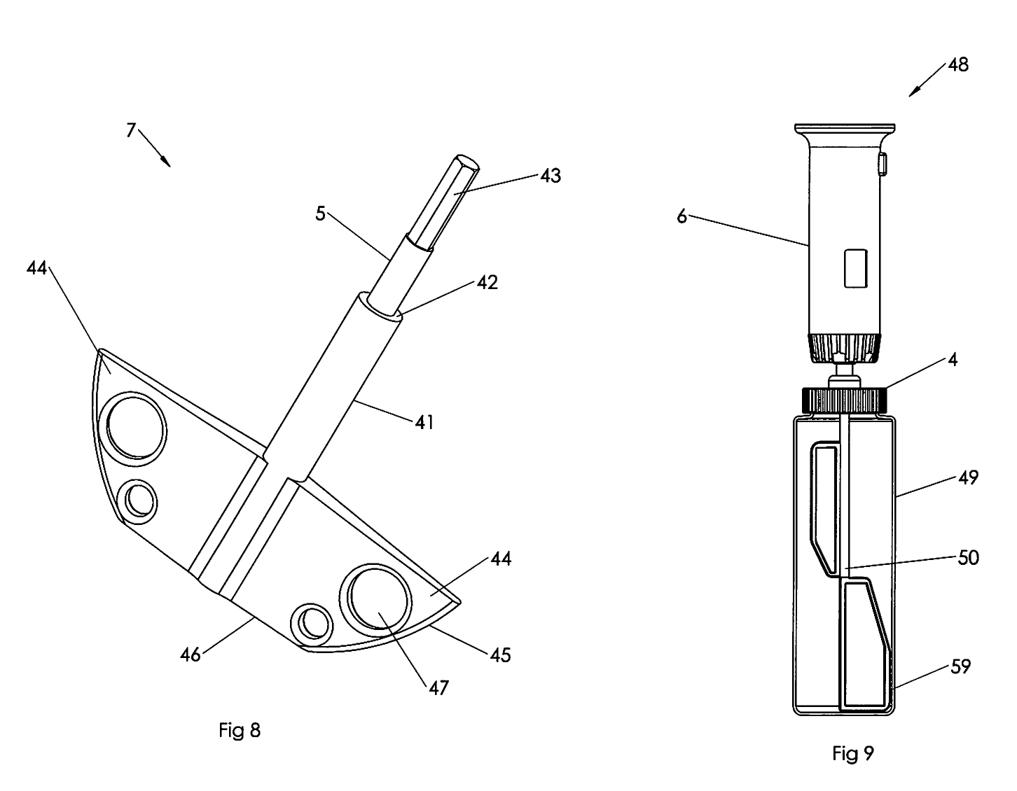

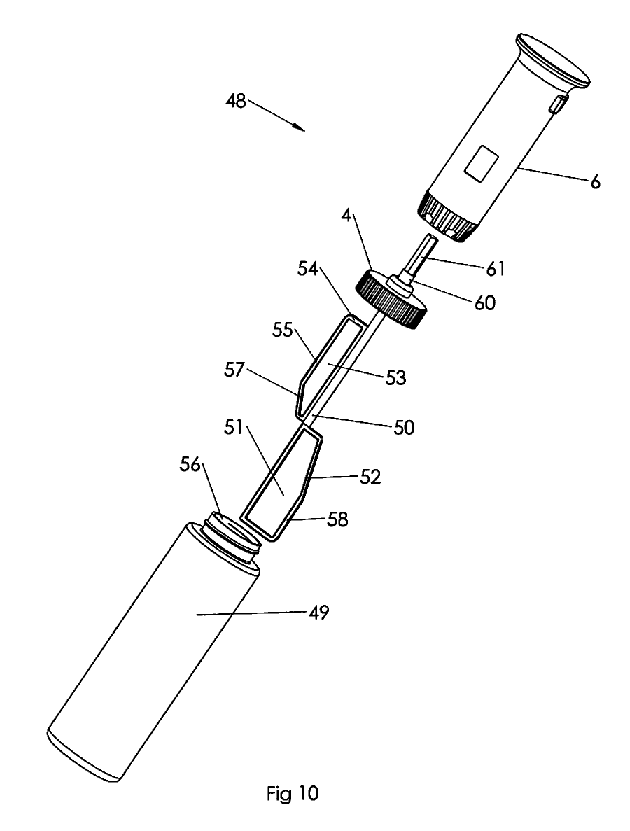

FIG. 6 shows a partial section of sealing cap 4. This is preferably molded from a chemically resistant polymer such as high molecular weight polyethylene (HMPE). It is also desirable that this polymer have friction properties making it suitable for its role as a bearing in mating with the outer diameter of stirring rod 5. HMPE has such properties and its use as a bearing material is well understood. Sealing cap 4 has a central hub 40 with bottom surface 38 and top surface 39 defining its lower and upper ends, respectively. The three bearing surfaces of sealing cap 4 can be seen in FIG. 6 and are denoted therein by reference nos. 31, 32 and 33. Internal grooves 34 are of such dimension to accommodate sealing o-rings 8. Tapered projection 35 incorporates an outside conical surface 36 which, when the cap is screwed onto top lid 3, serves to establish a liquid tight seal between the two parts (see FIG. 7). Threads 37 are of known female buttress thread geometry with dimensions suitable for mating with the male counterpart threads of top lid 3 as well as those of bottle 49 (see FIGS. 9 and 10).

FIG. 7 shows a portion of stirring rod 5 together with a partially sectioned sealing cap 4, o-rings 8 and top lid 3. Enlarged diameter portion 41 of stirring rod 5 is defined at its upper end by a stop shoulder 42. When the stirring device, such as a paddle 7 or whisk, is inserted into the top lid from underneath, it is stop shoulder 42 which properly limits axial travel and easily locates correct extension of the stirring device into bowl 2. FIG. 7 also shows the mating of conical surface 36 with edge 24 of FIG. 4. Engagement of female thread 37 and male thread 25 are also shown in this view. It is this novel combination of shaft seals, conical engagement sealing between plastic components and the inverted cup shape which allows the entire top lid 3, stirring rod 5 and motorized drive handle 6 to be placed in an inverted position (with the handle below the top lid and stirrer) following mixing of chemicals without danger of said chemicals leaking out onto the motorized drive handle 6 or table top on which the mixing device rests.

FIG. 8 shows stirring paddle 8 with rod bearing diameter portion 5 and smaller diameter hexagonal drive portion 43 at its top axial end and paddle faces 44 at its lower axial end. Paddle faces 44 include outer edges 45 which are preferably formed to lightly engage the curved inner walls of bowl 2 and bottom surface 46 and which are further preferably formed to lightly engage the inner bottom central surface of bowl 2. Stirring rod with its bearing surface 5 and hex shape 43 at the upper end is preferably made from aluminum with an anodized surface of stainless steel. The diameter defined by surface 5 preferably extends all the way to bottom surface 46. The paddle portions 44 which also includes cylindrical portion 41, having a larger diameter than that of the rod bearing diameter portion 5 and ending at surface 42, are molded from a chemically resistant but soft, flexible material such as silicone rubber. The metallic rod and molded paddle are joined either by adhesive means or insert molding methods. Paddle blades 44 also preferably include apertures 47 which can be generally round in shape and of suitable size to promote thorough mixing of the chemical ingredients.

FIG. 9 shows a second embodiment of the mixing device 48 of the present invention in which a bottle is utilized instead of a bowl and cover. The bottle 49 is shown cut vertically in half so as to reveal a novel stirring whisk 50 which will be further described below. This embodiment includes the same motorized handle 6 and sealing cap 4 as used in the first embodiment shown in FIG. 1.

FIG. 10 shows the second embodiment 48 in an exploded state. Stirring whisk 50 includes a lower trapezoid shape defined by an inner window 51 and a perimeter wall of generally uniform cross section. Upper angled wall 52 allows for easy removal of the stirring whisk 50 from bottle 49. Stirring whisk 50 also includes a second trapezoid shape defined by window 53 and another perimeter wall 54 of generally uniform cross section. Window 53 is dimensioned with its vertical member 55 at a distance close enough to the stirring axis so that it can be easily inserted through neck 56 of bottle 49 even though window portion 51 is already inside the bottle. Window 53 is preferably disposed 180° from window 51 and has a lower angled or sloping wall 57 which allows for easy insertion of the stirring whisk through neck 56. Window 51 has its outer edge dimensioned parallel to the axis of the whisk and bottle so that, in use, it sweeps close to the inner surface of the bottle but preferably does not touch it. The small gap 59 between the window 51 and the inner surface of the bottle 49 thus created is shown in FIG. 9. Stirring whisk 50 is made from suitable non-corroding metal, such as stainless steel or anodized aluminum, and includes an upper bearing and sealing diameter 60 and hexagonal section 61 which are identical to diameter 5 and hex diameter portion 43 respectively of paddle stirrer 7. This permits the same sealing cap 4 to be used with either the bowl device 1 or the bottle device 48.

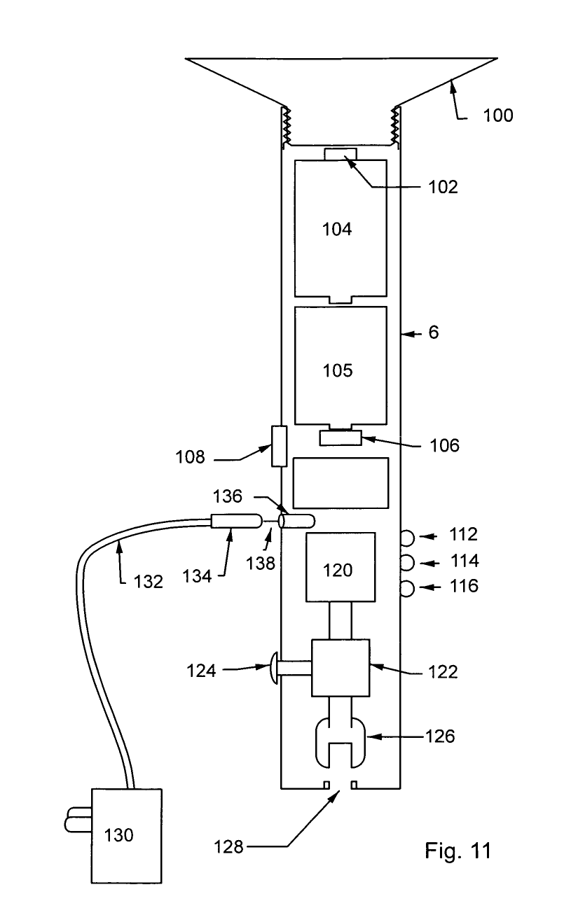

FIG. 11 is a simplified cross-sectional view of the motorized handle 6 of the present invention. Handle 6 includes an elongated cylindrical housing having a driving nose situated at one axial end thereof and an enlarged diameter base having a flat surface situated at the opposite axial end thereof. The enlarged diameter base and flat surface thereof provide a stable resting surface for the motorized handle and top lid when the top lid is removed from the bowl or bottle and placed in an inverted portion so that the base of the motorized handle rests on a table top or other horizontal support surface with the top lid still attached to the handle.

The cylindrical housing of the motorized handle defines an interior cavity or compartment for receiving and holding several components of the handle. More specifically, the interior cavity of the housing is accessible by removing the enlarged diameter base from one axial end of the housing. Preferably, in this regard, the base is exteriorly threaded over at least a portion thereof, the threaded portion being threadingly receivable by an interiorly threaded portion of the cylindrical housing and thus removably secured thereto.

Within the housing is situated one or more rechargeable or disposable batteries, which are preferably “C” or “D” size. The battery or batteries engage appropriate electrical contacts, for example, positioned on an interior surface of the removable base and within the interior cavity of the housing. One battery contact, or both, may be connected to an on/off power switch located on the exterior surface of the housing so that it is accessible to the user.

Power from the batteries is also provided through the switch to a DC (direct current) motor situated within the interior cavity of the housing. The shaft of the motor may be connected to a coupler having an axially disposed, hexagonally-shaped bore. This bore receives the hexagonally-shaped portion 43 or 61 of the various stirrers to couple the motor to the stirrers and so that energization of the motor will cause the stirrers to rotate.

Alternatively, the DC motor within handle 6 may be coupled to a transmission situated within the interior cavity of the housing. The transmission may be for the user to select a different (higher or lower) speed setting or a different (higher or lower) torque setting with which to rotate the stirrers. An electrical or mechanical switch mounted on the exterior surface of the handle housing and operatively coupled to the transmission may be provided for the user to select a desired speed or torque setting. If a transmission is provided, it may include an output shaft which may be connected to a coupler, such as described previously, which in turn receives and is coupled to the hexagonal end portion of the stiffer.

The motorized handle may further include a battery monitoring circuit. The circuit may be situated within the interior cavity of the housing, and is electrically connected to the battery, or batteries, to monitor the state of charge or condition of the battery or batteries. The battery monitoring circuit provides an output signal to at least one, but preferably three, light emitting diodes (LEDs) mounted for viewing by the user on the exterior surface of the handle housing. For example, and as shown in FIG. 11, three LEDs, emitting red, yellow and green lights when selectively energized by the battery monitoring circuit, may be included. Preferably, the red LED illuminates when the battery power is below about 25% of a predetermined power level; the yellow LED illuminates when the battery power is between about 25% and about 75% of the predetermined power level; and the green LED illuminates when the battery power is about 75% of the predetermined power level.

Furthermore, and as shown in FIG. 11, the present invention may include a battery charger to recharge the batteries of the motorized handle 6. The battery charger may, for example, include an AC (alternating current) or DC (direct current) converter module 130 which is pluggable into a household AC power wall outlet, and a male plug 134 attached on the end of a power cord 132 connected to the converter module, which plug may be selectively electrically connected via route 138 to a mating female connector 136 mounted on the housing of the handle. The female connector is electrically operatively coupled within the housing to the batteries 104-105 in order to recharge the batteries, the state of charge of which is monitored by the battery monitoring circuit described previously, or to power the DC motor using voltage from the AC power outlet.

As seen in FIG. 11, motorized handle 6 has base 100, battery contacts 102 and 106, power switch 108, battery monitoring circuit 109, red, yellow and green indicator LEDs 112, 114 and 116 respectively, direct current motor 120, transmission 122, transmission switch 124, tool coupler 126, and handle opening 128 for access to coupler 126.

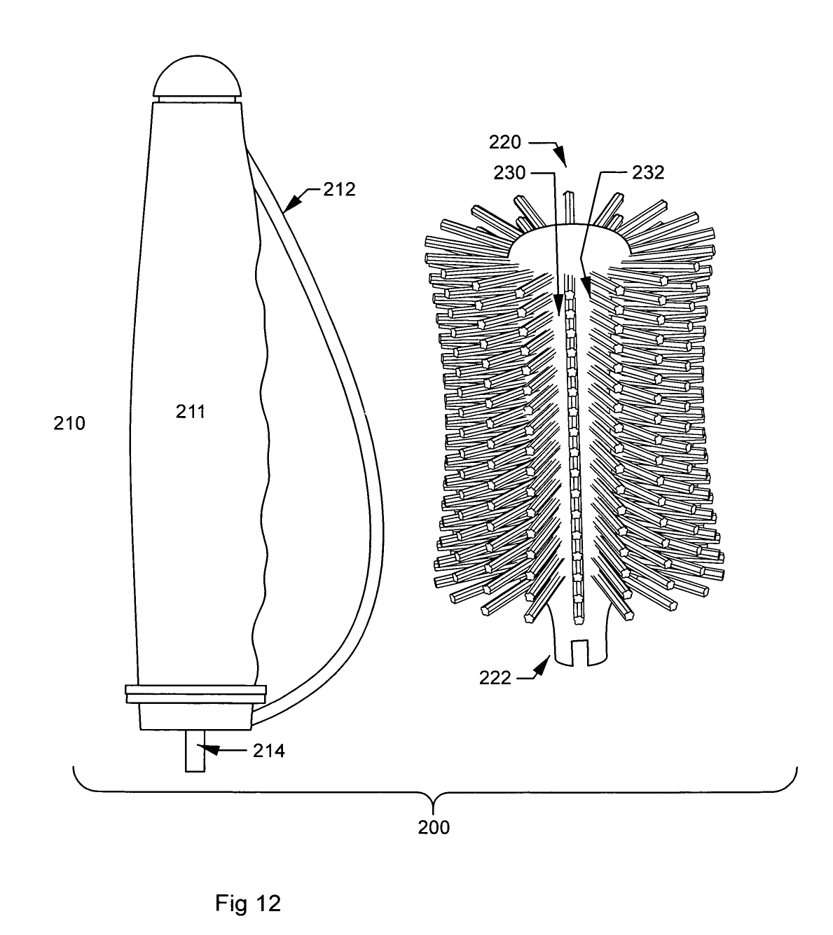

FIG. 12 depicts an alternative embodiment of apparatus of the invention provided by handle and brush combination 200 comprised of handle 210 in contoured case 210 and having strap 212, all of which is adapted for complementary brush 220 having coupler 222 for attaching to handle fixture 214. In this embodiment, brush 220 has a plurality of bristles arrayed along straight rows 230, but many other brush styles are contemplated for use herein.

As can be seen from the description of the design of this invention, all necessary features of easy and straightforward use together are provided.

It should be understood from the foregoing description of the present invention that, although the mixing apparatus is described for use with mixing of ingredients for hair coloring treatments, mixtures for other purposes may be prepared using the present invention.

Although preferred embodiments of the present invention have been described herein with reference to the accompanying drawings, it is to be understood that the invention is not limited to those precise embodiments and that various other changes and modifications may be effected herein by one skilled in the art without departing from the scope or spirit of the invention, and that it is intended to claim all such changes and modifications that fall within the scope of the invention.

1. An apparatus for blending or mixing hair colorant chemicals while minimizing stylist exposure to noxious fumes, comprising a mixing bowl molded from a polymeric material, an interlocking bowl top lid molded from the same or similar polymer, a motorized handle, and a stirring paddle or whisk having a rotatable shaft which passes through a sealing means removably affixed to the specially designed top lid and thence engaging a driving end of the motorized handle; wherein the top lid incorporates interlocking means at its outer edge such that it can be easily twist-locked into intimate contact with the bowl which is provided with mating lock surfaces; whereby when engaged, mating surfaces of the top lid and bowl form a seal which prevents or minimizes escape of mixture ingredients and odors from the enclosed volume defined by and between the lid and the bowl.

2. An apparatus as in claim 1 wherein the bowl edge is not circular and includes protrusions for a pouring spout and a structure located approximately opposite said spout for wiping excess coloring mixture off application brushes and a handle.

3. An apparatus as in claim 1 wherein the top lid is shaped at its edge so that, upon closing, it closely follows the non-uniform curvature of the bowl edge.

4. An apparatus as in claim 1 wherein the top lid is generally that of an inverted shallow bowl with a flat upper surface and curving walls dropping down to meet the edge configures to allow capture of fluids following mixing and disengagement from the bowl when the top lip is turned upside down and set aside.

5. An apparatus as in claim 4, further comprising a central hole and external threads for locking engagement with a removable cap having complementary, interiorly-formed threads to mate with the threaded neck of the top lid and which further contains sealing means for sliding/rotating contact with the rotatable paddle shaft.

6. An apparatus as in claim 5, wherein the axis of this cylindrical neck is located coaxially with the central axis of the bowl.

7. An apparatus as in claim 1 wherein a paddle or whisk is positioned within the bowl in close proximity to the interior walls and floor of the bowl but which allows suitable clearance therewith so as to assure satisfactory shearing action on substances placed therein when rotated within said bowl.

8. An apparatus as in claim 1 wherein motorized handle is removably engaged to the end of a shaft forming part of the paddle with hexagonal or other suitable engagement means.

9. An apparatus as in claim 7 wherein the paddle has rubberized blades disposed on opposite sides of a central axis and having an outer edge geometry shaped such as to be in close proximity to or engaging the inner walls and bottom of the bowl and wherein the paddle geometry and its flexible rubber construction, provides a positive wiping action against the bowl interior in order to create desirable shearing of powders and thick semi-liquid ingredients for thorough mixing.

10. An apparatus as in claim 9 wherein the paddle structure also includes a plurality of apertures, circular in shape and configured to effect a desired shearing action of thick ingredients while precluding useless plowing of ingredients during rotation as may occur without such apertures.

11. An apparatus as in claim 1 wherein the rubberized paddle is used at a low speed, high torque setting of the motorized handle.
